(19) United States
(12) Patent Application Publication
(10) Pub. No.: US 2023/0419087 A1
(43) Pub. Date: Dec. 28, 2023

(54) ADAPTERS FOR QUANTIZATION

(71) Applicant: QUALCOMM Incorporated, San Diego, CA (US)

(72) Inventors: Minseop PARK, Young-in (KR); Jaeseong YOU, Seoul (KR); Simyung CHANG, Suwon (KR); Markus NAGEL, Amsterdam (NL); Chirag Sureshbhai PATEL, San Diego, CA (US)

(21) Appl. No.: 18/330,990

(22) Filed: Jun. 7, 2023

Related U.S. Application Data
(60) Provisional application No. 63/355,472, filed on Jun. 24, 2022.

(51) Int. Cl. G06N 3/0495; G06N 3/044; G06N 3/08

(52) U.S. Cl. CPC G06N 3/0495; G06N 3/044; G06N 3/08

(57) ABSTRACT

A processor-implemented method for adaptive quantization in an artificial neural network (ANN) includes receiving an ANN model. The ANN model has multiple channels of target activations. A quantization module is incorporated between a first linear layer of the ANN and a second linear layer of the ANN to generate an adapted ANN. The quantization module scales a first set of weights and biases of the first linear layer based on a learnable quantization module parameter and scales a second set of weights of the second linear layer based on an inverse of the learnable quantization module parameter.

### CROSS-REFERENCE TO RELATED APPLICATION

The present application claims the benefit of U.S. Provisional Patent Application No. 63/355,472, filed on Jun. 24, 2022, and titled “ADAPTERS FOR QUANTIZATION,” the disclosure of which is expressly incorporated by reference in its entirety.

### FIELD OF THE DISCLOSURE

Aspects of the present disclosure generally relate to quantization in artificial neural networks.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Edge devices such as smartphones are widely used. Given the many useful applications of neural networks, there is increasing demand for use of edge devices and for personalized services for such edge devices. However, edge devices have limited computational resources and generalized models may utilize more complex networks and computational resources.

Transformer-based architectures have become the de-facto standard models for a wide range of natural language processing tasks. However, their memory footprint and high latency are prohibitive for efficient deployment and inference on resource-limited devices.

### SUMMARY

The present disclosure is set forth in the independent claims, respectively. Some aspects of the disclosure are described in the dependent claims.

In one aspect of the present disclosure, a processor-implemented method includes receiving an artificial neural network (ANN) model, the ANN model having a number of channels of target activations. The method further includes incorporating a quantization module between a first linear layer of the ANN and a second linear layer of the ANN to generate an adapted ANN. The quantization module scales a first set of weights and biases of the first linear layer based on a learnable quantization module parameter and scales a second set of weights of the second linear layer based on an inverse of the learnable quantization module parameter. The method may still further includes operating the adapted ANN model to generate an inference based on the learnable quantization module parameter.

Another aspect of the present disclosure is directed to an apparatus including means for receiving an artificial neural network (ANN) model, the ANN model having a number of channels of target activations. The apparatus further includes means for incorporating a quantization module between a first linear layer of the ANN and a second linear layer of the ANN to generate an adapted ANN. The quantization module scales a first set of weights and biases of the first linear layer based on a learnable quantization module parameter and scales a second set of weights of the second linear layer based on an inverse of the learnable quantization module parameter. The apparatus may still further include means for operating the adapted ANN model to generate an inference based on the learnable quantization module parameter.

In another aspect of the present disclosure, a non-transitory computer-readable medium with non-transitory program code recorded thereon is disclosed. The program code is executed by a processor and includes program code to receive an artificial neural network (ANN) model, the ANN model having a number of channels of target activations. The program code further includes program code to incorporate a quantization module between a first linear layer of the ANN and a second linear layer of the ANN to generate an adapted ANN. The quantization module scales a first set of weights and biases of the first linear layer based on a learnable quantization module parameter and scales a second set of weights of the second linear layer based on an inverse of the learnable quantization module parameter. The program code may still further include program code to operate the adapted ANN model to generate an inference based on the learnable quantization module parameter.

Another aspect of the present disclosure is directed to an apparatus having a memory and one or more processors coupled to the memory. The processor(s) is configured to receive an artificial neural network (ANN) model, the ANN model having a number of channels of target activations. The processor(s) is further configured to incorporate a quantization module between a first linear layer of the ANN and a second linear layer of the ANN to generate an adapted ANN. The quantization module scales a first set of weights and biases of the first linear layer based on a learnable quantization module parameter and scales a second set of weights of the second linear layer based on an inverse of the learnable quantization module parameter. The processor(s) may still further be configured to operate the adapted ANN model to generate an inference based on the learnable quantization module parameter.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a block diagram illustrating an example implementation of a quadapter module in an artificial neural network (ANN), in accordance with various aspects of the present disclosure.

FIG. 6 is a diagram illustrating example pseudocode for training a quadapter module, in accordance with various aspects of the present disclosure.

FIG. 7 is a flow diagram illustrating a processor-implemented method for adaptive quantization in an artificial neural network (ANN), in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Recently, transformer architectures have shown improvement in language modeling and natural language processing (NLP) tasks. Based on the conventional transformer architectures such as (but not limited to) bi-directional encoder representations from transformers (BERT), robustly optimized BERT approach (RoBERTa), XLNet, Transformer-XL, and the generative pre-trained transformer (GPT) family of transformers (e.g., GPT-2, GPT-3, GPT-4, etc.), language models may be pre-trained from large corpora of unlabeled text. Accordingly, such transformer architectures have become popular building blocks in conventional NLP pipelines, as well as in other areas such as computer vision and audio processing.

Despite providing performance improvements in many applications, pre-trained transformer-based models may be extremely large, sometimes exceeding billions of parameters, for example. Hence, efficient deployment of such transformer-based models on resource-constrained embedded systems including mobile devices (e.g., smartphones) and Internet of Things (IoT) devices, and even some systems in data centers, is challenging due to increased latency, energy consumption, and a prohibitively large memory footprint.

One effective method to address this problem is neural network quantization. Neural network quantization reduces memory consumption by using low-bit precision for weight and activation tensors. In addition, neural network quantization may reduce inference time and improve energy efficiency by employing low-bit fixed-point arithmetic instead of floating-point arithmetic.

Quantization, however, may introduce additional noise in the neural network that may lead to a reduction in the model's accuracy as well as an increase in computational complexity. For instance, transformer models may have numerous outliers in their activations. These activation outliers may lead to a larger quantization error. Some conventional approaches attempt to address the large quantization error by applying quantization-aware training (QAT). QAT involves a fine-tuning process based on the training dataset and training pipeline identical to the original model. However, QAT procedures may incur overfitting because QAT changes the parameters of the pre-trained model when adapting to an unfamiliar distribution or domain. Furthermore, many pre-trained language models may not grant access to the training dataset and pipeline forcing users to rely on arbitrary datasets and training pipelines for fine-tuning, which may also result in the model overfitting to the fine-tuning data.

To address these and other issues, aspects of the present disclosure are directed to an adapter for improved quantization in neural network models. A quantization adapter (quadapter) module may adapt to a domain shift resulting from quantization while preserving the initial model parameters. In some aspects, quantization-aware training and/or post-training quantization may also be applied. Accordingly, aspects of the present disclosure may beneficially reduce, and in some aspects, prevent overfitting when fine-tuning data for QAT, and improve quantization performance in data-scarce environments, as well as for in distribution settings.

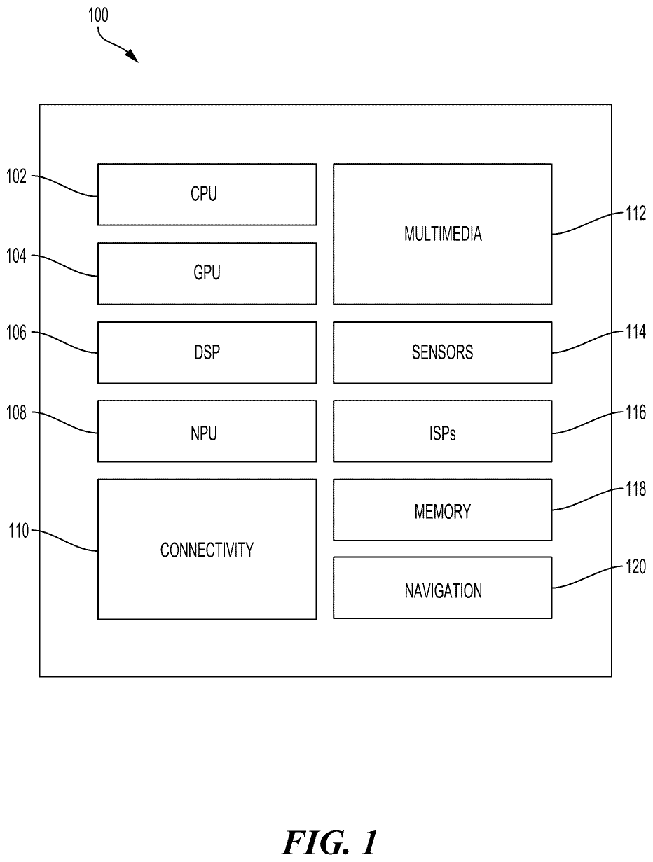

FIG. 1 illustrates an example implementation of a system-on-a-chip (SOC) 100, which may include a central processing unit (CPU) 102 or a multi-core CPU configured for adaptive quantization in an artificial neural network. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive an artificial neural network (ANN) model, the ANN model having a plurality of channels of target activations. The general-purpose processor 102 may also include code to incorporate a quantization module between a first linear layer of the ANN and a second linear layer of the ANN to generate an adapted ANN. The quantization module scales a first set of weights and biases of the first linear layer based on a learnable quantization module parameter and scales a second set of weights of the second linear layer based on an inverse of the learnable quantization module parameter. The general-purpose processor 102 may further include code to operate the adapted ANN model to generate an inference based on the learnable quantization module parameter.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

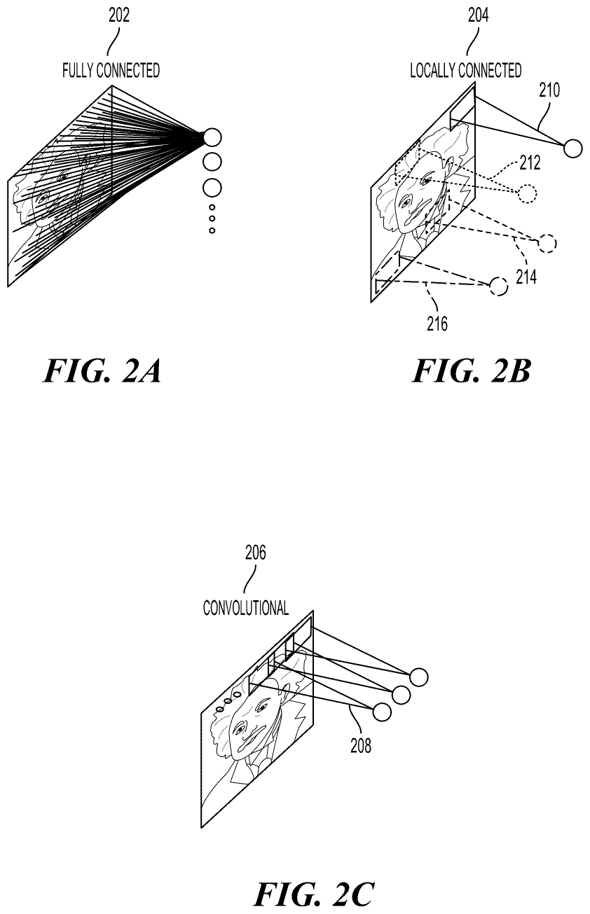

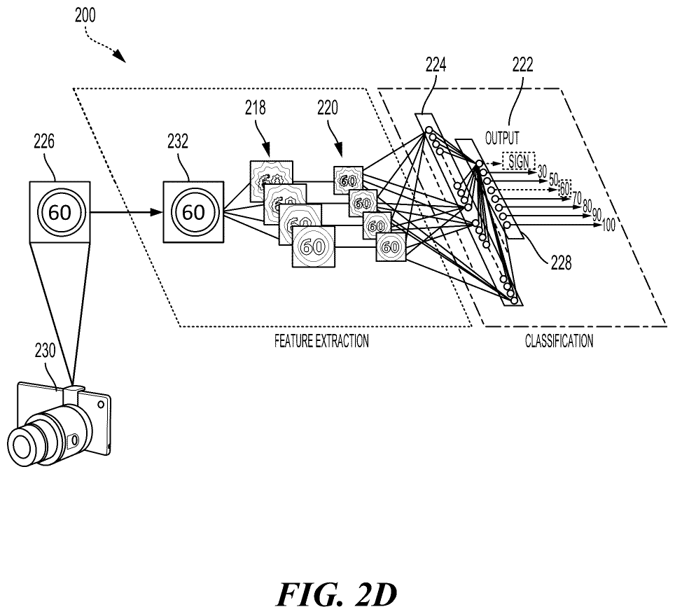

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

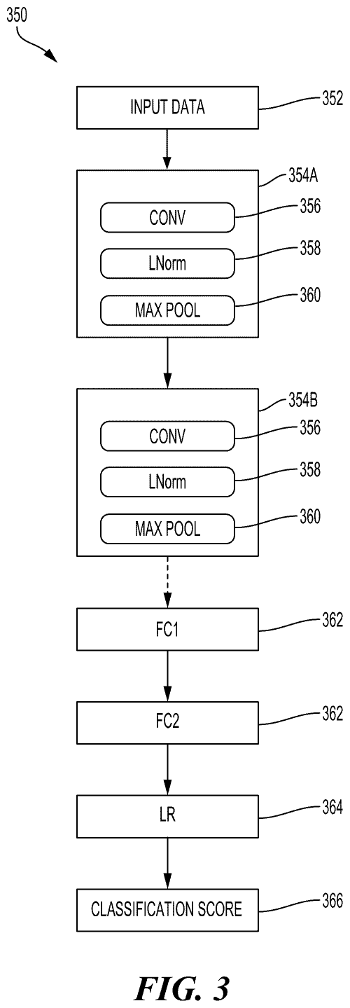

FIG. 3 is a block diagram illustrating a deep convolutional network (DCN) 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the deep convolutional network 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layers 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

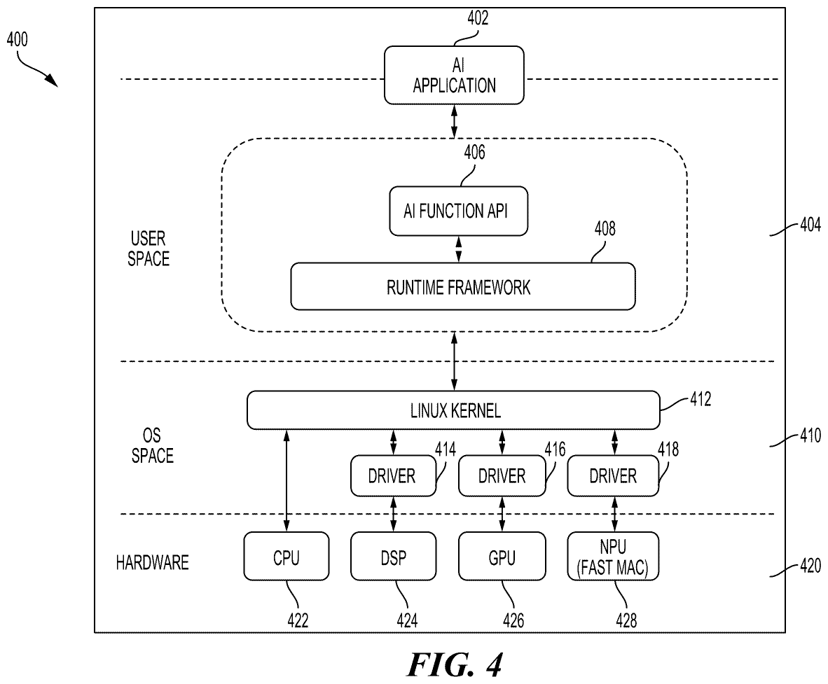

FIG. 4 is a block diagram illustrating an exemplary software architecture 400 that may modularize artificial intelligence (AI) functions. Using the architecture 400, applications may be designed that may cause various processing blocks of a system-on-a-chip (SoC) 420 (for example a CPU 422, a DSP 424, a GPU 426 and/or an NPU 428) (which may be similar to SoC 100 of FIG. 1) to support adaptive quantization for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space, such as a Linux Kernel 412, running on the SoC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The AI application 402 may be configured to call functions defined in the user space 404 that may, for example, provide for the detection and recognition of a scene indicative of the location in which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

The run-time engine 408, which may be compiled code of a Runtime Framework, may be further accessible to the AI application 402. The AI application 402 may cause the run-time engine 408, for example, to request a scene estimate at a particular time interval or triggered by an event detected by the user interface of the AI application 402. When caused to estimate the scene, the run-time engine 408 may in turn send a signal to the operating system 410, such as the Kernel 412, running on the SoC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as the driver 414-418 for the DSP 424, for the GPU 426, or for the NPU 428. In the exemplary example, the differential neural network may be configured to run on a combination of processing blocks, such as the CPU 422 and the GPU 426, or may be run on the NPU 428.

As described, aspects of the present disclosure are directed to an adapter for improved quantization in neural network models. In accordance with aspects of the present disclosure, an artificial neural network (ANN) may be adapted by incorporating a quantization adapter module (the quantization adapter module may be referred to as a “quadapter”). A quadapter may linearly scale the input channels of the ANN and revert after quantization. As such, the identity relation may be maintained to enable retention of the model parameters.

The quadapter may include a set of learnable parameters and may be configured to perform a linear scaling before or after a quantizer Q for a target activation. That is, the quadapter may linearly scale the input channels of the ANN and revert them back after quantization. In doing so, an identity relationship between quantization parameters may enable model parameters to be maintained. Instead, only a set of learnable quantization parameters are adapted. The scaling and inverse scaling of an activation may be folded to a weight and bias of a preceding layer and to a weight of a following layer. For example, given a forward pass of two linear layers,

y=W₂(W₁x+b₁)+b₂, (1)

where x represents an input, y represent an output, W₁ and b₁ respectively represent weights and biases of a first linear layer, and W₂ and b₂ respectively represent weights and biases of a second linear layer. A quadapter module output ŷ may be defined as follows:

$$\hat{y} = {Q}_{{θ}_{2}} ( {W}_{2} {A}^{- 1} ) {Q}_{{θ}_{a}} ( {Q}_{{θ}_{1}} ( {AW}_{1} ) x + {Ab}_{1} ) + {b}_{2} \qquad ( 2 )$$

$$= {Q}_{{θ}_{2}} ( {W}_{2}^{′} ) {Q}_{{θ}_{a}} ( {Q}_{{θ}_{1}} ( {W}_{1}^{′} ) x + {b}_{1}^{′} ) + {b}_{2} \qquad ( 3 )$$

Where A=diag(α) is a diagonal matrix with Aᵢᵢ=αᵢ, where α∈ [symbol] ^{d} is a learnable quantization (quadapter) parameter, and d is the intermediate activation dimension. Q_{θ}_{₁} and Q_{θ}_{₂} are the weight quantizers and Q_{θ}_{ₐ} a is the activation quantizer. Each quantizer Q_{θ} may quantize its input values (e.g., values in its input channel, which may be referred to as a “channel of a target activation”) based on the quantization range parameter θ=(θₘᵢₙ, θₘₐₓ). The quantization (quadapter) parameter α may be trained during a training phase and fused (e.g., fixed) during an inference phase. W₁′ and b₁′ represent fused weights and biases of a first linear layer. W₂′ represents fused weights of a second layer at the inference time (e.g., as in Equation 3).

As in Equation 2, the forward scaling and the inverse scaling may correspond across three nested quantizers that may be strongly nonlinear operations. Therefore, the quadapter parameter α should be learned rather than set analytically because a single analytical solution may not be sufficient to balance the quantization burden between the two layers.

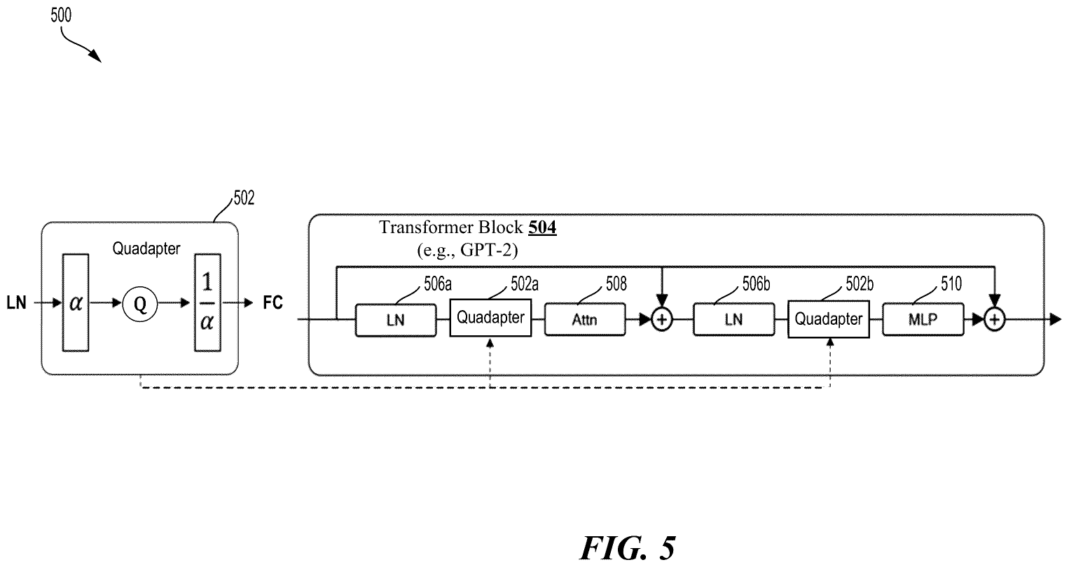

FIG. 5 is a block diagram illustrating an example implementation 500 of a quadapter module 502 in an artificial neural network (ANN), in accordance with various aspects of the present disclosure. Referring to FIG. 5, the quadapter module 502 is configured, as described, to apply the quadapter parameter α to weights and biases of a preceding linear layer (e.g., layer normalization (LN) layer). The quadapter module 502 may also apply an inverse of the quadapter parameter α to weights of the succeeding layer (e.g., a fully-connected (FC) layer). The quantizer parameter Q may apply a quantization process to weights and activations of each layer of the ANN.

In the implementation example 500 of FIG. 5, the quadapter module 502 is inserted in an ANN 504. In the example implementation, the ANN 504 has a transformer architecture. Of course, this is merely an example and the quadapter module 502 may be included in other types of ANNs. For ease of illustration, a single transformer block is shown in FIG. 5. However, it should be understood that the ANN 504 may include multiple transformer blocks.

One or more instances of the quadapter module 502 may be incorporated into the ANN 504. For example, a first quadapter module 502a may be inserted between a first LN layer 506a and an attention layer 508. A second quadapter module 502b may be inserted between a second LN layer 506b and a multilayer perceptron (MLP) layer 510. In some aspects, a quadapter module 502 may also be included between a final LN layer and a final logit projection.

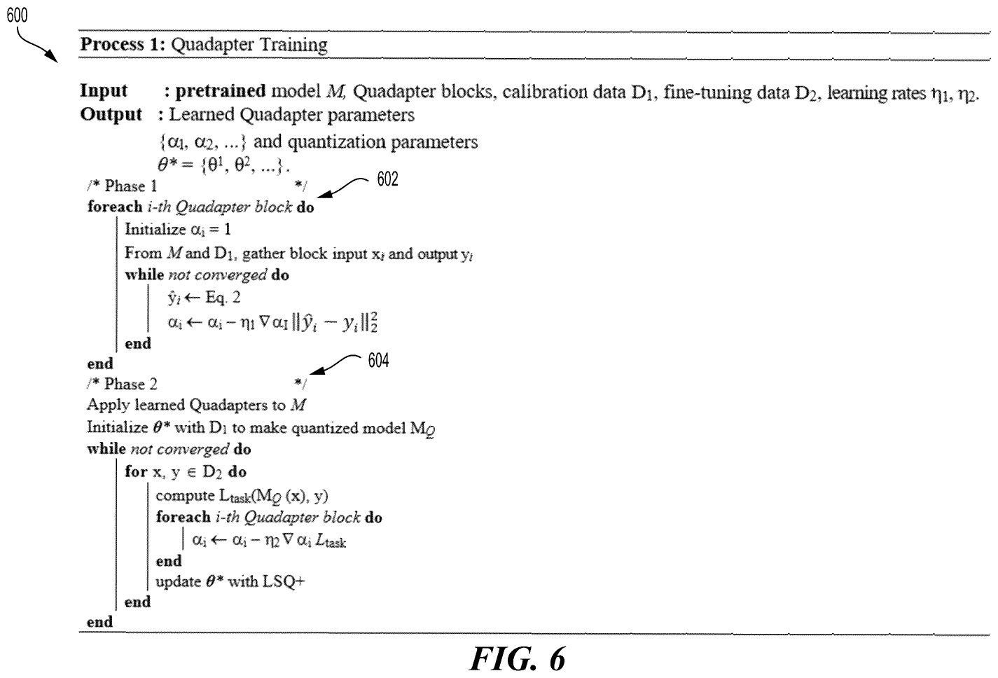

FIG. 6 is a diagram illustrating example pseudocode 600 for training a quadapter module, in accordance with various aspects of the present disclosure. Referring to FIG. 6, the learning of a quadapter module (e.g., 502 of FIG. 5) may be conducted in two phases: a block-wise calibration phase 602 and an end-to-end fine-tuning phase 604. In the block-wise calibration phase 602, each of the quadapter module instances (e.g., 502a, 502b) may be initialized to \vec{1} and trained with a set of calibration data for quantization. Each quadapter module (e.g., 502a, 502b) may be trained independently on a per-quadapter module basis. The local objective for each block may, for example, be the L2 loss:

$${arg min}_{α} {‖ y - \hat{y} ‖}_{2}^{2} . \qquad ( 4 )$$

The quadapter parameters a are learned by minimizing the block-wise quantization error with the calibration data for quantization. In some aspects, the quadapter module output ŷ may be computed in a dynamic quantization mode, where the statistics are obtained per batch. The quantization parameters Q minimum/maximum may be computed dynamically in every batch considering the effect of the quadapter parameters.

A quadapter module (e.g., 502a, 502b) resulting from the block-wise calibration phase 602 is a post-training quantization (PTQ) approach that is independent of the end-to-end fine-tuning phase 604.

The end-to-end fine-tuning phase 604 may begin with more accommodating quantization parameters (e.g., less extreme minimum/maximum statistics) because more moderate values may be produced in contrast to more extreme outliers during the block-wise calibration phase 602. As a result, the fine-tuning process may converge more quickly.

The statistics for quantization may be computed as in a static quantization based on the same calibration data as in the block-wise calibration phase 602. The quadapter module (e.g., 502a, 502b) may then be trained to minimize the end-to-end task loss using a training data set. In some aspects, the quantization parameters may be jointly learned while the ANN model parameters (e.g., weights) may be fixed.

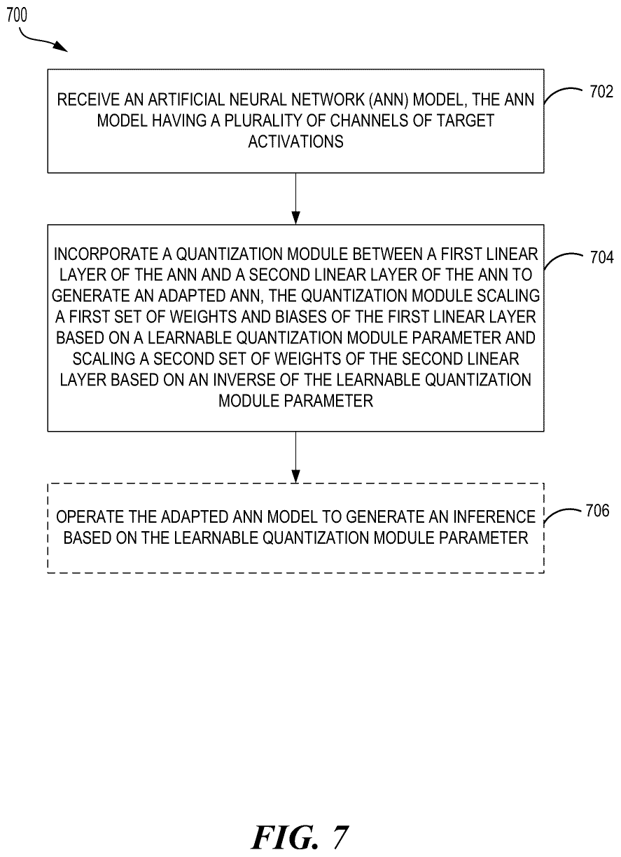

FIG. 7 is a flow diagram illustrating a processor-implemented method 700 for adaptive quantization in an artificial neural network, in accordance with various aspects of the present disclosure. The processor-implemented method 700 may be performed by a processor such as CPU 102, GPU 104, or NPU 108, for example.

As shown in FIG. 7, at block 702, the processor receives an artificial neural network (ANN) model. The ANN model has multiple channels of target activations. The ANN may comprise a transformer neural network such as (but not limited to) bi-directional encoder representations from transformers (BERT), a robustly optimized BERT approach (RoBERTa)-based transformer, an XLNet-based transformer, Transformer-XL-based transformer, or a generative pre-trained transformer (GPT), for instance. In some aspects, the ANN model may comprise a pre-trained model.

At block 704, the processor incorporates a quantization module between a first linear layer of the ANN and a second linear layer of the ANN to generate an adapted ANN. The quantization module scales a first set of weights and biases of the first linear layer based on a learnable quantization module parameter and scales a second set of weights of the second linear layer based on an inverse of the learnable quantization module parameter. For instance, as described with reference to FIG. 5, the quadapter module 502a may be inserted between the first LN layer 506a and the attention layer 508 of the ANN 504.

At block 706, the processor may optionally operate the adapted ANN model to generate an inference based on the learnable quantization module parameter. In some aspects, the adapted ANN model may operate to generate the inference based on a learnable quantization parameter. The quantization parameter may be determined based on a task loss of the adapted ANN model.

Implementation examples are described in the following numbered clauses:
1. A processor-implemented method, comprising:
   receiving an artificial neural network (ANN) model, the ANN model having a plurality of channels of target activations; and
   incorporating a quantization module between a first linear layer of the ANN model and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.
2. The processor-implemented method of clause 1, further comprising scaling a target activation in each channel of the plurality of channels of target activations based on a learnable quantization parameter.
3. The processor-implemented method of clause 1 or 2, further comprising determining the learnable quantization parameter based on a task loss of the adapted ANN model.
4. The processor-implemented method of any of clauses 1-3, in which the learnable quantization parameter and the learnable quantization module parameter are jointly determined.
5. The processor-implemented method of any of clauses 1-4, further comprising re-training the adapted ANN model using a quantization-aware training process.
6. The processor-implemented method of any of clauses 1-5, in which the ANN model comprises a transformer neural network model.
7. The processor-implemented method of any of clauses 1-6, in which the transformer neural network model comprises one of a bi-directional encoder representations from transformers (BERT), a robustly optimized BERT approach (RoBERTa)-based transformer, an XLNet-based transformer, a Transformer-XL-based transformer, or a generative pre-trained transformer (GPT).
8. The processor-implemented method of any of clauses 1-7, further comprising operating the adapted ANN model to generate an inference based on the learnable quantization module parameter.
9. An apparatus, comprising:
   a memory; and
   at least one processor coupled to the memory, the at least one processor configured:
      to receive an artificial neural network (ANN) model, the ANN model having a plurality of channels of target activations; and
      to incorporate a quantization module between a first linear layer of the ANN and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.
10. The apparatus of clause 9, in which the at least one processor is further configured to scale a target activation in each channel of the plurality of channels of target activations based on a learnable quantization parameter.
11. The apparatus of clause 9 or 10, in which the at least one processor is further configured to determine the learnable quantization parameter based on a task loss of the adapted ANN model.
12. The apparatus of any of clauses 9-11, in which the at least one processor is further configured to jointly determine the learnable quantization parameter and the learnable quantization module parameter.
13. The apparatus of any of clauses 9-12, in which the at least one processor is further configured to re-train the adapted ANN model using a quantization-aware training process.
14. The apparatus of any of clauses 9-13, in which the ANN model comprises a transformer neural network model.
15. The apparatus of any of clauses 9-14, in which the transformer neural network model comprises one of a bi-directional encoder representations from transformers (BERT), a robustly optimized BERT approach (RoBERTa)-based transformer, an XLNet-based transformer, a Transformer-XL-based transformer, or a generative pre-trained transformer (GPT).
16. The apparatus of any of clauses 9-15, in which the at least one processor is further configured to operate the adapted ANN model to generate an inference based on the learnable quantization module parameter.
17. A non-transitory computer-readable medium having program code recorded thereon, the program code executed by a processor and comprising:
   program code to receive an artificial neural network (ANN) model, the ANN model having a plurality of channels of target activations; and
   program code to incorporate a quantization module between a first linear layer of the ANN model and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.
18. The non-transitory computer-readable medium of clause 17, in which the program code further comprises program code to scale a target activation in each channel of the plurality of channels of target activations based on a learnable quantization parameter.
19. The non-transitory computer-readable medium of clause 17 or 18, in which the program code further comprises program code to determine the learnable quantization parameter based on a task loss of the adapted ANN model.
20. The non-transitory computer-readable medium of any of clauses 17-19, in which the program code further comprises program code to operate the adapted ANN model to generate an inference based on the learnable quantization module parameter.
21. An apparatus, comprising:
   means for receiving an artificial neural network (ANN) model, the ANN model having a plurality of channels of target activations; and
   means for incorporating a quantization module between a first linear layer of the ANN model and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.
22. The apparatus of clause 21, further comprising means for scaling a target activation in each channel of the plurality of channels of target activations based on a learnable quantization parameter.
23. The apparatus of clause 21 or 22, further comprising means for determining the learnable quantization parameter based on a task loss of the adapted ANN model.
24. The apparatus of any of clauses 21-23, further comprising means for jointly determining the learnable quantization parameter and the learnable quantization module parameter.
25. The apparatus of any of clauses 21-24, further comprising means for re-training the adapted ANN model using a quantization-aware training process.
26. The apparatus of any of clauses 21-25, in which the ANN model comprises a transformer neural network model.
27. The apparatus of any of clauses 21-26, in which the transformer neural network model comprises one of a bi-directional encoder representations from transformers (BERT), a robustly optimized BERT approach (RoBERTa)-based transformer, an XLNet-based transformer, a Transformer-XL-based transformer, or a generative pre-trained transformer (GPT).
28. The apparatus of any of clauses 21-27, further comprising means for operating the adapted ANN model to generate an inference based on the learnable quantization module parameter.

In some aspects, the receiving means, incorporating means, operating means, determining means, scaling means, and/or training means may be the GPU 104, program memory associated with the GPU 104, fully connected layers 362, NPU 428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
receiving an artificial neural network (ANN) model, the ANN model having a plurality of channels of target activations; and
incorporating a quantization module between a first linear layer of the ANN model and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.

2. The processor-implemented method of claim 1, further comprising scaling a target activation in each channel of the plurality of channels of target activations based on a learnable quantization parameter.

3. The processor-implemented method of claim 2, further comprising determining the learnable quantization parameter based on a task loss of the adapted ANN model.

4. The processor-implemented method of claim 2, in which the learnable quantization parameter and the learnable quantization module parameter are jointly determined.

5. The processor-implemented method of claim 1, further comprising re-training the adapted ANN model using a quantization-aware training process.

6. The processor-implemented method of claim 1, in which the ANN model comprises a transformer neural network model.

7. The processor-implemented method of claim 6, in which the transformer neural network model comprises one of a bi-directional encoder representations from transformers (BERT), a robustly optimized BERT approach (RoBERTa)-based transformer, an XLNet-based transformer, a Transformer-XL-based transformer, or a generative pre-trained transformer (GPT).

8. The processor-implemented method of claim 1, further comprising operating the adapted ANN model to generate an inference based on the learnable quantization module parameter.

9. An apparatus, comprising:
a memory; and
at least one processor coupled to the memory, the at least one processor configured:
to receive an artificial neural network (ANN) model, the ANN model having a plurality of channels of target activations; and
to incorporate a quantization module between a first linear layer of the ANN and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.

10. The apparatus of claim 9, in which the at least one processor is further configured to scale a target activation in each channel of the plurality of channels of target activations based on a learnable quantization parameter.

11. The apparatus of claim 10, in which the at least one processor is further configured to determine the learnable quantization parameter based on a task loss of the adapted ANN model.

12. The apparatus of claim 10, in which the at least one processor is further configured to jointly determine the learnable quantization parameter and the learnable quantization module parameter.

13. The apparatus of claim 9, in which the at least one processor is further configured to re-train the adapted ANN model using a quantization-aware training process.

14. The apparatus of claim 9, in which the ANN model comprises a transformer neural network model.

15. The apparatus of claim 14, in which the transformer neural network model comprises one of a bi-directional encoder representations from transformers (BERT), a robustly optimized BERT approach (RoBERTa)-based transformer, an XLNet-based transformer, a Transformer-XL-based transformer, or a generative pre-trained transformer (GPT).

16. The apparatus of claim 9, in which the at least one processor is further configured to operate the adapted ANN model to generate an inference based on the learnable quantization module parameter.

17. A non-transitory computer-readable medium having program code recorded thereon, the program code executed by a processor and comprising:
program code to receive an artificial neural network (ANN) model, the ANN model having a plurality of channels of target activations; and
program code to incorporate a quantization module between a first linear layer of the ANN model and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.

18. The non-transitory computer-readable medium of claim 17, in which the program code further comprises program code to scale a target activation in each channel of the plurality of channels of target activations based on a learnable quantization parameter.

19. The non-transitory computer-readable medium of claim 18, in which the program code further comprises program code to determine the learnable quantization parameter based on a task loss of the adapted ANN model.

20. The non-transitory computer-readable medium of claim 17, in which the program code further comprises program code to operate the adapted ANN model to generate an inference based on the learnable quantization module parameter.

21. An apparatus, comprising:
means for receiving an artificial neural network (ANN) model, the ANN model having a plurality of channels of target activations; and
means for incorporating a quantization module between a first linear layer of the ANN model and a second linear layer of the ANN model to generate an adapted ANN model, the quantization module scaling a first set of weights and biases of the first linear layer based on a learnable quantization module parameter and scaling a second set of weights of the second linear layer based on an inverse of the learnable quantization module parameter.

22. The apparatus of claim 21, further comprising means for scaling a target activation in each channel of the plurality of channels of target activations based on a learnable quantization parameter.

23. The apparatus of claim 22, further comprising means for determining the learnable quantization parameter based on a task loss of the adapted ANN model.

24. The apparatus of claim 22, further comprising means for jointly determining the learnable quantization parameter and the learnable quantization module parameter.

25. The apparatus of claim 21, further comprising means for re-training the adapted ANN model using a quantization-aware training process.

26. The apparatus of claim 21, in which the ANN model comprises a transformer neural network model.

27. The apparatus of claim 26, in which the transformer neural network model comprises one of a bi-directional encoder representations from transformers (BERT), a robustly optimized BERT approach (RoBERTa)-based transformer, an XLNet-based transformer, a Transformer-XL-based transformer, or a generative pre-trained transformer (GPT).

28. The apparatus of claim 21, further comprising means for operating the adapted ANN model to generate an inference based on the learnable quantization module parameter.
